(19) United States
(12) Patent Application Publication
(10) Pub. No.: US 2025/0253913 A1
(43) Pub. Date: Aug. 7, 2025

(54) METHOD, DEVICE AND COMPUTER STORAGE MEDIUM OF COMMUNICATION

(71) Applicant: NEC CORPORATION, Minato-ku (JP)

(72) Inventors: Peng GUAN, Beijing (CN); Yukai GAO, Beijing (CN); Gang WANG, Beijing (CN)

(73) Assignee: NEC CORPORATION, Minato-ku (JP)

(21) Appl. No.: 18/856,104

(22) PCT Filed: Apr. 15, 2022
(86) PCT No.: PCT/CN2022/087081

§ 371 Date: Oct. 11, 2024

(51) Int. Cl. H04B 7/06

(52) U.S. Cl. CPC H04B 7/0658; H04B 7/0626

(57) ABSTRACT

Embodiments of the present disclosure relate to methods, devices and computer readable media for communication. A terminal device determines CSI and channel quality information based on a measurement on a set of RSs from a network device, and determines a compression method at least based on the channel quality information. The terminal device compresses the CSI based on the compression method, and transmits, to the network device, the channel quality information and the compressed CSI. The network device determines the compression method applied for the compressed CSI based on the channel quality information, and recoveries CSI based on the compressed CSI and the compression method. In this way, CSI feedback overhead and compression performance may be balanced.

### TECHNICAL FIELD

Embodiments of the present disclosure generally relate to the field of telecommunication, and in particular, to methods, devices and computer storage media of communication for an artificial intelligence (AI) or machine learning (ML) based channel state information (CSI) feedback.

### BACKGROUND

Currently, a codebook based CSI feedback is supported, including type I single panel codebook, type I multi-panel codebook, type II codebook, type II port selection codebook, enhanced type II codebook, enhanced type II port selection codebook, and further enhanced type II port selection codebook. As known, overhead of CSI feedback is a major concern. It is agreed that an AI or ML based method may provide significant overhead reduction. However, details of an AI or ML based CSI feedback are still incomplete and need to be further developed.

### SUMMARY

In general, embodiments of the present disclosure provide methods, devices and computer storage media of communication for an AI or ML based CSI feedback.

In a first aspect, there is provided a method of communication. The method comprises: determining, at a terminal device, channel state information and channel quality information based on a measurement on a set of reference signals from a network device; determining a compression method at least based on the channel quality information; compressing the channel state information based on the compression method; and transmitting, to the network device, the channel quality information and the compressed channel state information.

In a second aspect, there is provided a method of communication. The method comprises: receiving, at a network device and from a terminal device, channel quality information and compressed channel state information; determining a compression method applied for the compressed channel state information based on the channel quality information; and recovering channel state information based on the compressed channel state information and the compression method.

In a third aspect, there is provided a terminal device. The terminal device comprises a processor configured to cause the terminal device to perform the method according to the first aspect of the present disclosure.

In a fourth aspect, there is provided a network device. The network device comprises a processor configured to cause the network device to perform the method according to the second aspect of the present disclosure.

In a fifth aspect, there is provided a computer readable medium having instructions stored thereon. The instructions, when executed on at least one processor, cause the at least one processor to perform the method according to the first aspect of the present disclosure.

In a sixth aspect, there is provided a computer readable medium having instructions stored thereon. The instructions, when executed on at least one processor, cause the at least one processor to perform the method according to the second aspect of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example communication network in which some embodiments of the present disclosure can be implemented;

FIG. 2 illustrates a schematic diagram illustrating an example process of an AI or ML based CSI feedback in which some embodiments of the present disclosure can be implemented;

FIG. 3 illustrates a schematic diagram illustrating a process of communication according to embodiments of the present disclosure;

FIG. 4 illustrates an example method of communication implemented at a terminal device in accordance with some embodiments of the present disclosure;

FIG. 5 illustrates an example method of communication implemented at a network device in accordance with some embodiments of the present disclosure; and

FIG. 6 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

It is observed that as an AI or ML model, an autoencoder or transformer based CSI feedback is to compress CSI at user equipment (UE) and to recover the CSI at a network (NW). Some of key parameters of the AI/ML model may include an input/output dimension, a compression method and a quantization method, etc., and may need to be aligned at both NW and UE side.

It is also observed that, with the same number of compressed bits (or, the same compression ratio), compression performance is better in higher signal noise ratio (SNR) regime. In other words, to achieve the same compression performance, more bits (or, lower compression ratio) are required when the SNR is lower. This means that an adaptive compression ratio may help to improve the overall performance and to balance the overhead and performance.

Within a third generation partnership project (3GPP) CSI feedback framework, it is to be addressed how to exchange information required to align parameters of an encoder and a decoder, support an adaptive compression method, and design an UCI format for compressed CSI feedback.

In view of this, embodiments of the present disclosure provide a solution of communication for a CSI feedback so as to overcome the above or other potential issues. In this solution, a terminal device determines a compression method at least based on channel quality information to compress CSI, and transmit the channel quality information and the compressed CSI to a network device. The network device determines the compression method at least based on the channel quality information and recoveries CSI based on the compression method and the compressed CSI. In this way, a dynamic compression method may be applied to obtain compressed CSI based on channel quality. Accordingly, CSI feedback overhead and compression performance may be balanced.

For convenience, definitions of some terms in the present disclosure may be listed as below.
The terms “a compression method” may refer to at least one of the following parameters: a compression ratio (CR), the number of compressed bits, the number of quantization bits, output or input dimension of encoder, output or input dimension of decoder, the number of layers in an encoder or decoder, dimension or size of each layer, activation function, and so on. Each of these parameters may be set per frequency unit, per time unit or per spatial unit. For example, for a CR, a CR per frequency unit refers to the number of compressed bits per sub-band, per PRB, etc., A CR per time unit refers to the number of compressed bits per slot, per frame, etc., A CR per spatial unit refers to the number of compressed bits per port, per beam, etc.
The terms “a CR” may refer to one of the following definitions:
   Definition 1: CR=output dimension of encoder/input dimension of encoder. For example, the input dimension of encoder may refer to the number of ports X the number of sub-bands, and the output dimension of encoder may refer to the number of compressed bits or the number of compressed bits/the number of quantization bits;
   Definition 2: CR=2× output dimension of encoder/input dimension of encoder. 2 may stand for real and imaginary part of a complex value. 2 may stand for dual polarizations. 2 may also be replaced by other constants;
   Definition 3: CR=the number of quantization bits X output dimension of encoder/input dimension of encoder;
   Definition 4: CR=2× the number of quantization bits X output dimension of encoder/input dimension of encoder;
   Definition 5: CR=the number of bits required to report codebook-based CSI/the number of bits required to report compressed CSI. The codebook-based CSI may refer to type I single panel codebook, type I multi-panel codebook, type II codebook, type II port selection codebook, enhanced type II codebook, enhanced type II port selection codebook, and further enhanced type II port selection codebook;

The expression “a higher compression ratio” in the present disclosure means less bits to compress the same amount of information, i.e., CR1=¼ is a higher comparison ratio compared to CR2=½. But in terms of the value of the fractional number, CR1<CR2. In other words, “CR1<CR2” means “CR1 is a higher compression ratio than CR2” and “with CR1, less bits are required to compress the same amount of information”;

CR may be not a specific value of CR and may be an index value indicating CR. For example, CR index 1 may correspond to ½, CR index 2 may correspond to ¼, etc.;

CR may comprise no compression. For example, CR index 0 may correspond to “no compression”.
The terms “quantization information or method” may refer to at least one of the following:

The number of quantization bits, such as 1-bit, 2-bit, 4-bit, etc.;

The method of quantization, such as uniform quantization, non-uniform quantization;

A ceil, floor or round operation applied in quantization function, such as ceil/floor/round value of (x×2^{(B-1)})/(2^{(B-1)}) if B-bit uniform quantization is used;

If the total number of compressed bits is fixed, the higher compression ratio means more bits for quantization;

The quantization information may be not a specific value and may be an index value indicating the quantization information. For example, quantization index 0 may correspond to 1-bit quantization, quantization index 1 may correspond to 2-bit quantization, etc.,
The terms “channel quality” or “channel quality information” may be associated or reflected with at least one of the following measurement/report matrices: a rank indicator (RI), a channel quality indicator (CQI), a signal noise ratio (SNR), reference signal receive power (RSRP), a signal interference noise ratio (SINR), a received signal strength indicator (RSSI), reference signal receive quality (RSRQ), and supported or reported or scheduled modulation and coding scheme (MCS), supported or reported or scheduled modulation scheme, supported or reported or scheduled coding rate, supported or reported or scheduled efficiency.
The terms “UE capability reporting” may comprise at least one of the following:

Supported number of bits for a precoder matrix indicator (PMI)/CSI report for auto-encoder based CSI feedback, candidate value is (52, 104, 208, 312, etc.), in general, an integer number, smaller than the codebook based CSI feedback;

Supported compression ratio, candidate value is (½, ¼, ⅛, 1/16, etc.), in general, a fractional number;

Supported quantization methods. For example, candidate value is (1, 2, 3, 4, etc.), in general, an integer number, if quantization information is the number of quantization bits; or

Supported input dimension of encoder, in other words, supported number of ports for auto-encoder based CSI feedback, support number of sub-bands for auto-encoder based CSI feedback, support size of sub-bands for auto-encoder based CSI feedback, support bandwidth for auto-encoder based CSI feedback.
The terms “CSI report configuration” may comprise at least one of the following:

Report quantity: (NW configures UE to report one or many of) compressed CSI/PMI, compression ratio, quantization method, and at least one of the following:

CR1, RI, LI, PMI, CQI, wideband/subband PMI, wideband/subband CQI, wideband/subband amplitude/phase, wideband/subband co-phasing, index or linear combination of spatial/frequency/time-domain discrete Fourier transform (DFT)/discrete Cosine transform (DCT) basis;

SNR, RSRP, SINR, RSSI, RSRQ, supported modulation scheme, supported coding rate, supported efficiency;

type I single panel codebook, type I multi-panel codebook, type II codebook, type II port selection codebook, enhanced type II codebook, enhanced type II port selection codebook, and further enhanced type II port selection codebook; or transform-domain of CSI, including spatial-frequency domain, time-frequency domain, angular-delay domain, etc.;

Compressed CSI/PMI may comprise a channel compression in a transform-domain including spatial-frequency domain, time-frequency domain, angular-delay domain, etc.;

Time-domain and frequency-domain information, PUCCH/PUSCH resources for the CSI report; or

CSI-resource for measurement.
The terms “AI/ML model configuration” may comprise at least one of the following:

Start/end (or, activation/deactivation) of AI/ML model training/inference (or, report compressed bits for CSI/PMI report);

AI/ML model information: auto-encoder-based CSI feedback, transformer-based CSI feedback, or other types of AI/ML model such as multilayer perceptrons (MLPs), convolution neural networks (CNNs), and recurrent neural networks (RNNs) and so on;

Auto-encoder information or transformer information comprising at least one of the following:

Supported number of bits for PMI/CSI report for auto-encoder based CSI feedback, candidate value is (52, 104, 208, 312, etc.), in general, an integer number, smaller than the codebook based CSI feedback;

Supported compression ratio, candidate value is (½, ¼, ⅛, 1/16, etc.), in general, a fractional number;

Supported quantization methods. For example, candidate value is (1, 2, 3, 4, etc.), in general, an integer number, if quantization information is the number of quantization bits;

Supported input dimension of encoder, in other words, supported number of ports for auto-encoder based CSI feedback, support number of subbands for auto-encoder based CSI feedback, support size of subbands for auto-encoder based CSI feedback, support bandwidth for auto-encoder based CSI feedback;

Other parameters and hyper-parameters to describe AI/ML model (or, to align encoder/decoder) including a number or a maximum number of layers, a number or a maximum number of hidden layers, layer types, layer shapes (i.e., filter size, a number of channels/filters), a number and a maximum number of neurons per each layer, a number and a maximum number of neurons, and connections between layers, learning rate, loss function, cost function, activation function, mini-batch size, number of training iterations, momentum, number of hidden units, weight decay, activation sparsity, nonlinearity, weight initialization, regularization constant, number of epochs, number of branches in a decision tree, number of clusters in a clustering algorithm and any other hyper-parameters.
The terms “precoder”, “precoding”, “precoding matrix”, “beam”, “spatial relation information”, “spatial relation info”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably.
The terms “group”, “subset” and “set” may be used interchangeably.
The terms “relationship”, “mapping” and “correspondence” may be used interchangeably.
The terms “recovery”, “decode” and “decompress” may be used interchangeably, and the term “encode” and “compress” may be used interchangeably.
The terms “compressed CSI”, “compressed PMI” and “compressed CSI/PMI” may be used interchangeably.
One panel discussed herein refers to one or more antenna elements deployed at a certain area of a terminal device. A panel discussed herein can refer to downlink panel, uplink panel, panel type, panel status, capability value set, reference signal (RS) resource, RS resource set, antenna port, antenna port group, beam, beam group. In this regard, the terms (and their equivalent expressions) “panel”, “panel type”, “set of antenna port(s)”, “antenna element(s)”, “antenna array(s)” may be used interchangeably.
Panel information discussed herein can refer to UE panel index/identification (ID), downlink panel ID, uplink panel ID, panel type indication, panel status indication, capability value set index, RS resource ID, RS resource set ID, antenna port ID, antenna port group ID, beam ID, beam group ID.
The term “network”/“network device(s)” refer to one or more network devices. Accordingly, terms “network”, “network device(s)” and “one or more network devices” may be used interchangeably.
The term “AI/ML model” may involve model training and model inference. The model training and the model inference may be considered as deployed jointly at NW and UE. It does not preclude AI/ML model training/inference is deployed at NW/UE/operations and maintenance (OAM). If those functions are located in one network entity, a virtual counterpart may be considered, for example, if model training is at NW, virtual UEs may be simulated in training.
The term “data collection” may be a function that provides input data to Model training and Model inference functions. AI/ML algorithm specific data preparation (e.g., data pre-processing and cleaning, formatting, and transformation) is not carried out in the Data Collection function. Examples of input data may include measurements from UEs or different network entities, feedback from Actor, output from an AI/ML model.
The term “training data” may be data needed as input for the AI/ML Model Training function.
The term “inference data” may be data needed as input for the AI/ML Model Inference function.
The term “model training” may refer to a function that performs the ML model training, validation, and testing which may generate model performance metrics as part of the model testing procedure. The Model Training function is also responsible for data preparation (e.g. data pre-processing and cleaning, formatting, and transformation) based on Training Data delivered by a Data Collection function, if required.
The term “model inference” may refer to a function that provides AI/ML model inference output (e.g. predictions or decisions). The Model inference function is also responsible for data preparation (e.g. data pre-processing and cleaning, formatting, and transformation) based on Inference Data delivered by a Data Collection function, if required.
The term “actor” may refer to a function that receives the output from the Model inference function and triggers or performs corresponding actions. The Actor may trigger actions directed to other entities or to itself.

Principles and implementations of the present disclosure will be described in detail below with reference to the figures.

### Example of Communication Network

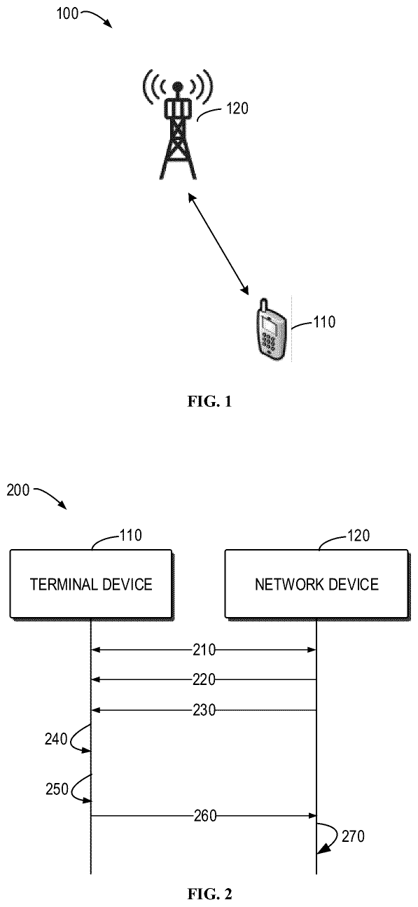

FIG. 1 illustrates a schematic diagram of an example communication network 100 in which some embodiments of the present disclosure can be implemented. As shown in FIG. 1, the communication network 100 may include a terminal device 110 and a network device 120. In some embodiments, the network device 120 may provide a serving cell (also referred to as a cell herein), and the terminal device 110 may be located in the cell and may be served by the network device 120. It is to be understood that the number of devices or cells in FIG. 1 is given for the purpose of illustration without suggesting any limitations to the present disclosure. The communication network 100 may include any suitable number of network devices and/or terminal devices and/cells adapted for implementing implementations of the present disclosure.

As shown in FIG. 1, the terminal device 110 may communicate with the network device 120 via a channel such as a wireless communication channel. In some embodiments, the terminal device 110 may communicate with the network device 120 via one or more beam pairs.

The communications in the communication network 100 may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

In some embodiments, the terminal device 110 may receive, from the network device 120, a configuration for CSI measurement and report via a DL control channel transmission. For example, the DL control channel transmission may be a PDCCH transmission. Of course, any other suitable forms are also feasible.

In some embodiments, the terminal device 110 may perform CSI measurement to determine CSI and transmit an uplink control information (UCI), e.g., a CSI report to the network device 120 via an UL control channel transmission. For example, the UL control channel transmission may be a PUCCH transmission. Of course, any other suitable forms are also feasible.

In some embodiments, the terminal device 110 may transmit the CSI by a codebook based CSI feedback process. In some embodiments, the codebook based CSI feedback process may be based on type I codebook or type II codebook. In the case of type I codebook, the terminal device 110 may report a single discrete Fourier transform (DFT) beam for precoding of each layer. In the case of type II codebook, the terminal device 110 may report L (L>1) strongest beams from DFT basis, and use linear combination of the selected beams to construct precoder vectors.

For example, codebook-based CSI may refer to type I single panel codebook, type I multi-panel codebook, type II codebook, type II port selection codebook, enhanced type II codebook, enhanced type II port selection codebook, and further enhanced type II port selection codebook.

In some embodiments, the terminal device 110 may transmit the CSI by an AI or ML based CSI feedback process. In some embodiments, the AI or ML based CSI feedback process may be based on an autoencoder. The autoencoder is a type of artificial neural network used to learn efficient codings of unlabeled data (unsupervised learning). The encoding is validated and refined by attempting to regenerate the input from the encoding. The autoencoder learns a representation (encoding) for a set of data, typically for dimensionality reduction, by training the network to ignore insignificant data (“noise”).

In some alternative embodiments, the AI or ML based CSI feedback process may be based on a transformer. The transformer is a deep learning model that adopts a mechanism of attention, differentially weighting significance of each part of an input. Of course, the AI or ML based CSI feedback process may adopt any other suitable schemes existing or to be developed in future.

FIG. 2 illustrates a schematic diagram illustrating an example process 200 of an AI or ML based CSI feedback in which some embodiments of the present disclosure can be implemented. For the purpose of discussion, the process 200 will be described with reference to FIG. 1. The process 200 may involve the terminal device 110 and the network device 120 as illustrated in FIG. 1. It is to be understood that the steps and the order of the steps in FIG. 2 are merely for illustration, and not for limitation. For example, the order of the steps may be changed. Some of the steps may be omitted or any other suitable additional steps may be added.

With reference to FIG. 2, the terminal device 110 may transfer 210 information of UE capability with the network device 120. For example, the network device 120 may transmit, to the terminal device 110, a radio resource control (RRC) configuration regarding an UE capability report. The terminal device 110 may report capability of the terminal device 110 to the network device 120 based on the RRC configuration.

The information of UE capability may comprise AI/ML capability on NW or UE side, for example, a supported AI/ML model, algorithm, size or dimension, computational power or complexity or time. Assuming that AI/ML model training may be carried out on NW or UE or OAM side.

Continue to refer to FIG. 2, the network device 120 may transmit 220, to the terminal device 110, a RRC (re) configuration message to configure a CSI report. For example, information configured by the RRC (re) configuration message may comprise a CSI report configuration and an AI/ML model configuration.

The network device 120 may transmit 230, to the terminal device 110, CSI-RS(s) for a channel measurement. The terminal device 110 may perform 240 the channel measurement by measuring CSI-RS(s) to determine CSI. In some embodiments, the terminal device 110 may determine information of a channel matrix as CSI. In this way, an explicit CSI feedback may be achieved. In some embodiments, the terminal device 110 may determine information of a precoding matrix (for example, PMI) as CSI. In this way, an implicit CSI feedback may be achieved.

The terminal device 110 may compress 250 the CSI by an encoding procedure. Then the terminal device 110 may transmit 260 the compressed CSI to the network device 120 via UCI but in compressed bits.

Upon reception of the compressed CSI, the network device 120 may recovery 270 CSI from the compressed bits by a decoding procedure. Then the CSI may be used for any suitable further processes.

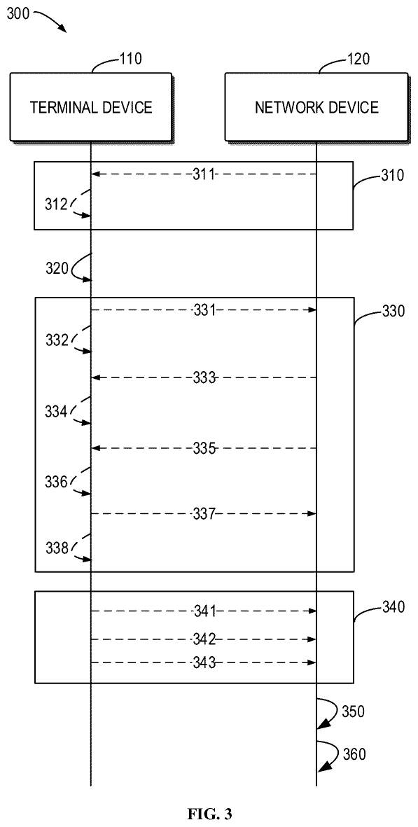

Embodiments of the present disclosure provide a solution for a CSI feedback to exchange information required to align parameters of encoder and decoder, to support adaptive compression method and to design UCI format for compressed CSI feedback. The detailed description will be made with reference to FIG. 3 below.

### Example Implementation of Csi Feedback

FIG. 3 illustrates a schematic diagram illustrating a process 300 of communication according to embodiments of the present disclosure. For the purpose of discussion, the process 300 will be described with reference to FIG. 1. The process 300 may involve the terminal device 110 and the network device 120 as illustrated in FIG. 1. It is to be understood that the steps and the order of the steps in FIG. 3 are merely for illustration, and not for limitation. For example, the order of the steps may be changed. Some of the steps may be omitted or any other suitable additional steps may be added.

As shown in FIG. 3, the terminal device 110 determines 310 CSI and channel quality information based on a measurement on a set of reference signal (RSs) from the network device 120. For example, the terminal device 110 may receive 311 the set of RSs from the network device 120. The set of RSs may be a set of CSI-RSs or any other suitable RSs. Then the terminal device 110 may perform 312 a channel measurement based on the set of RSs to obtain the CSI and channel quality information.

In some embodiments, the CSI may comprise at least information of a precoding matrix. For example, the CSI may comprise at least one of PMI or a precoding matrix. As another example, the CSI may comprise a channel matrix. Of course, the CSI may comprise any combination of PMI, a precoding matrix and a channel matrix.

In some embodiments, the channel quality information may comprise at least one of CQI, RI, SNR, RSRP, SINR, RSSI, RSRQ, supported or reported or scheduled MCS, supported or reported or scheduled modulation scheme, supported or reported or scheduled coding rate, or supported or reported or scheduled efficiency. It is to be understood that the channel quality information may also adopt any other suitable forms.

Continue to refer to FIG. 3, the terminal device 110 determines 320 a compression method at least based on the channel quality information. In some embodiments, the compression method is an AI or ML based compression. For example, the AI or ML based compression may comprise at least an encoding part of an autoencoder. As another example, the AI or ML based compression may comprise at least an encoding part of a transformer. It is to be understood that the AI or ML based compression may also adopt any other suitable forms.

In some embodiments, the terminal device 110 may implicitly report the compression method based on a relationship between the compression method and the channel quality information. In these embodiments, the number of bits required for quantization may be considered as a fixed number, for example 2-bit or any other suitable number.

In some embodiments, the relationship and/or the quantization may be predefined. In some embodiments, the relationship and/or the quantization may be configured via NW signaling. In some embodiments, the relationship and/or the quantization may be reported as UE capability or suggestion.

In some embodiments, the relationship may be expressed as a step or piecewise function, or a predefined look-up table, or via explicitly signaling describing each entry, or a combination of those mentioned. The entry means a correspondence between a compression parameter value and a channel quality parameter value. Of course, the relationship may also be expressed in any other suitable forms.

For example, the relationship may be a relationship between CQI and CR, a relationship between CQI and the number of compressed bits, a relationship between RI and CR, a relationship between MCS and CR, etc., In some embodiments, a priority of different channel quality parameters may be defined. For example, channel quality parameter A (e.g., RI)>channel quality parameter B (e.g., CQI). When “channel quality parameter A (e.g., RI)-compression method” is considered, if channel quality parameter A (e.g., RI) is larger or smaller than a threshold, a fixed compression method is applied no matter of channel quality parameter B (e.g., CQI) measured.

In some embodiments, the terminal device 110 may determine an applied set of compression parameter values based on at least one of the following: a mapping between the channel quality information and at least one compression parameter value in the set of compression parameter values, or a mapping among at least two compression parameter values in the set of compression parameter values. In some embodiments, the set of compression parameters comprises at least one of a CR, the number of quantization bits, or the number of compressed bits. Of course, any other suitable compression parameters are also feasible.

In some embodiments, if channel quality indicated by the channel quality information is below first threshold quality, the terminal device 110 may determine a fixed compression method (also referred to as a first predetermined compression method herein) as the compression method. In some embodiments, if channel quality indicated by the channel quality information is below second threshold quality, the terminal device 110 may determine that no compression is applied. In some embodiments, if channel quality indicated by the channel quality information is above third threshold quality, the terminal device 110 may determine a fixed compression method (also referred to as a second predetermined compression method herein) as the compression method.

In some embodiments, multiple compression methods may be defined for the same channel quality. In some embodiments, the terminal device 110 may select one of the multiple compression methods based on a configuration or an indication from the network device. In some embodiments, the terminal device 110 may select one of the multiple compression methods based on UE capability or category.

For illustration, some example embodiments on the determination of the compression method will be described below in connection with Embodiments 1 to 2.

### Embodiment 1

In this embodiment, the terminal device 110 may implicitly report CR based on a relationship between CR and channel quality.

Some examples of the relationship are shown in Tables 1 to 4 below by taking a CR as an example of the set of compression parameters and a CQI as an example of the channel quality information.

TABLE 1
Example mapping between CQI Index and CR

| CQI index | Compression ratio |
|---|---|
| CQI < CQI_1 | CR1 |
| CQI_1 ≤ CQI < CQI_2 | CR2 |
| CQI_2 ≤ CQI < CQI_3 | CR3 |
| . . . | . . . |

TABLE 2
Example mapping between CQI Index and CR

| CQI index | Compression ratio |
|---|---|
| CQI < CQI_1 | No compression |
| CQI_1 ≤ CQI < CQI_2 | CR1 |
| CQI_2 ≤ CQI < CQI_3 | CR2 |
| . . . | . . . |

TABLE 3
Example mapping between CQI Index and CR

| CQI index | Compression ratio |
|---|---|
| CQI < CQI_1 | CR1 |
| CQI_1 ≤ CQI < CQI_2 | CR2 |
| CQI_2 ≤ CQI < CQI_3 | CR3 |
| . . . | . . . |
| CQI_(k − 1) ≤ CQI | CRk |

TABLE 4
Example mapping between CQI Index and CR

| CQI index | Compression ratio |
|---|---|
| CQI < CQI_1 | (CR1_1, CR1_2) |
| CQI_1 ≤ CQI < CQI_2 | (CR2_1, CR2_2) |
| CQI_2 ≤ CQI < CQI_3 | (CR3_1, CR3_2) |
| . . . | . . . |
| CQI_(k − 1) ≤ CQI | (CRk_1, CRk_2) |

In Tables 1 to 4, CR1>CR2> . . . >CRk in terms of fractional number value. For example, CR1 has the lowest compression ratio ½, CR2 has compression ratio ¼, CR3 has compression ratio ⅛, and so on. The CQI index may be a wideband CQI. Of course, the CQI index may also be a sub-band CQI. The CQI index may be one-shot value, averaged or filtered or weighted value, possibly in a specific time. CQI_1, CQI_2, . . . , CQI (k-1) denote the thresholds/range of CQI index(es) to apply different CRs, and may be predefined, be signaled by NW, or be reported as UE capability or suggestion.

As shown in Table 1, if CQI is smaller than CQI_1, CR1 is determined as CR. In other words, different CRs are used for different CQI ranges, and for those smaller than a predetermined CQI (e.g., CQI_1), the same low CR is used. As shown in Table 2, if CQI is smaller than CQI_1, no compression is done. As shown in Table 3, if CQI is greater than or equal to CQI_(k-1), CRk is determined as CR, i.e., the same high CR is used.

As shown in Table 4, multiple CRs are defined for the same threshold or range, which can be further selected via NW configuration or via UE capability or category.

Assuming that CR1_1>CR1 2. CR1_2 and CR1_1 may be used for supporting high-end and low-end UE with different AI/ML model (e.g., encoding) capabilities respectively. Alternatively, a default value may also be assumed to be used, for example, the highest/lowest/first/last one of the multiple CRs may be assumed to be used. It is to be understood that Tables 1 to 4 are merely examples, and are not intended for limitation.

In this way, applied CR is indicated implicitly via a channel quality report. In addition, the number of quantization bits depends on channel quality. Thus, an adaptive compression method may be achieved and bits for reporting CR and quantization information may be saved.

### Embodiment 2

In this embodiment, the terminal device 110 may implicitly report quantization information based on a relationship between quantization information and channel quality.

Some examples of the relationship are shown in Tables 5 to 9 below by taking a CR and quantization information as examples of the set of compression parameters and a CQI as an example of the channel quality information.

TABLE 5
Example mapping between CQI Index
and Number of Quantization Bits

| CQI index | B-bit quantization |
|---|---|
| CQI < CQI_1 | B1 |
| CQI_1 ≤ CQI < CQI_2 | B2 |
| CQI_2 ≤ CQI < CQI_3 | B3 |
| . . . | . . . |

TABLE 6
Example mapping between CQI Index
and Number of Quantization Bits

| CQI index | B-bit quantization |
|---|---|
| CQI < CQI_1 | B1 |
| CQI_1 ≤ CQI < CQI_2 | B2 |
| CQI_2 ≤ CQI < CQI_3 | B3 |
| . . . | . . . |
| CQI_(k − 1) ≤ CQI | Bk |

TABLE 7
Example mapping between CQI Index
and Number of Quantization Bits

| CQI index | B-bit quantization |
|---|---|
| CQI < CQI_1 | (B_1, B1_2) |
| CQI_1 ≤ CQI < CQI_2 | (B2_1, B2_2) |
| CQI_2 ≤ CQI < CQI_3 | (B3_1, B3_2) |
| . . . | . . . |
| CQI_(k − 1) ≤ CQI | (Bk_1, Bk_2) |

TABLE 8
Example mapping among CQI Index, Number
of Quantization Bits and CR

| CQI index | B-bit quantization | Compression ratio |
|---|---|---|
| CQI < CQI_1 | B1 | CR1 |
| CQI_1 ≤ CQI < CQI_2 | B2 | CR2 |
| CQI_2 ≤ CQI < CQI_3 | B3 | CR3 |
| . . . | . . . | . . . |
| CQI_(k − 1) ≤ CQI | Bk | CRk |

TABLE 9
Example mapping between Number of Quantization Bits and CR

| B-bit quantization | Compression ratio |
|---|---|
| B1 | CR1 |
| B2 | CR2 |
| B3 | CR3 |
| . . . | . . . |
| Bk | CRk |

In Tables 5 to 9, assuming that the quantization information is the number of quantization bits. B in B-bit quantization denotes the number of quantization bits. In general, a candidate value of B is an integer number, for example, 1, 2, 3, 4, etc., For example, B1>B2> . . . ,>Bk in terms of integer number value, or in other words, more bits are used for quantization with a lower CQI. Of course, an increasing order of B1, B2, . . . , Bk is also feasible.

As shown in Table 5, if CQI is smaller than CQI_1, B1 is determined as the number of quantization bits. In other words, different quantization are used for different CQI ranges, and for those smaller than a predetermined number (e.g., CQI_1), the same high B is used. As shown in Table 6, if CQI is greater than or equal to CQI_(k-1), Bk is determined as the number of quantization bits, i.e., the same small B is used.

As shown in Table 7, multiple quantization are defined for the same threshold or range, which can be further selected via NW configuration or via UE capability or category. Assuming that B1_1>B1_2. B1_2 and B1_1 may be used for supporting high-end and low-end UE with different AI/ML model (e.g., encoding) capabilities respectively. Alternatively, a default value may also be assumed to be used, for example, the highest/lowest/first/last one of the multiple quantization may be assumed to be used.

As shown in Table 8, a mutual relationship between quantization information, CR and channel quality is considered.

As shown in Table 9, a mutual relationship between quantization information and CR is considered. That is, quantization information may be determined by CR, and vice versa. In this example, Bi*CRi may be a fixed value. It is to be understood that Tables 5 to 9 are merely examples, and are not intended for limitation.

In this way, applied quantization information is indicated implicitly via a channel quality report. An adaptive compression method may be achieved and bits for reporting CR and quantization information may be saved.

Continue to refer to FIG. 3, upon determination of the compression method, the terminal device 110 compresses 330 the CSI based on the compression method. Some example embodiments on the compression of the CSI will be described in connection with Embodiments 3 to 4.

### Embodiment 3

In some embodiments, the terminal device 110 may transmit 331 an indication of the compression method to the network device 120. In this way, the terminal device 110 may report the compression method applied or to be applied. In some embodiments, the terminal device 110 may transmit the indication together with compressed CSI in a CSI report. In some embodiments, the terminal device 110 may separately transmit the indication via other UL signaling such as UCI, UL medium access control (MAC) control element (CE), PUCCH, PUSCH and so on. In these embodiments, the terminal device 110 may start 332 the compression of the CSI at a predetermined timing after the transmission of the indication.

In some alternative embodiments, the terminal device 110 may receive 333 a confirmation for the indication from the network device 120 and start 334 the compression of the CSI at a predetermined timing after the reception of the confirmation. In some embodiments, the predetermined timing may be X time units, where X≥0.

In some embodiments, the compression method reported by the terminal device 110 may be a suggestion for the network device 120 to update a configuration for the terminal device 110. In some embodiments, the network device 120 may update a time-domain configuration based on the reported compression method. For example, the network device 120 may configure a larger or smaller periodicity of CSI measurement or report for the terminal device 110.

In some embodiments, the network device 120 may update a frequency-domain configuration based on the reported compression method. For example, the network device 120 may configure more or less sub-bands, PRBs, or a larger or smaller sub-band size for CSI measurement or report for the terminal device 110.

In some embodiments, the network device 120 may update an antenna-port-domain configuration based on the reported compression method. For example, the network device 120 may configure more or less ports for CSI measurement or report for the terminal device 110.

In some embodiments, the network device 120 may update a beam-domain configuration based on the reported compression method. For example, the network device 120 may configure more or less resources for CSI measurement or report for the terminal device 110.

In some embodiments, the network device 120 may update a resource for the transmission of the CSI based on the reported compression method. For example, the network device 120 may assign more or less PUSCH or PUCCH resources for the terminal device 110.

In some embodiments, the network device 120 may update a format for the transmission of the compressed CSI based on the reported compression method. For example, the network device 120 may indicate more bits to report compressed CSI or indicate whether sub-band information is reported.

### Embodiment 4

In some embodiments, the network device 120 may transmit 335 an indication of the compression method to the terminal device 110. In this way, the network device 120 may configure or indicate the compression method applied or to be applied. In some embodiments, the network device 120 may transmit the indication via signaling scheduling, assignment, grant or configured grant which comprises information about modulation and/or coding scheme. In some embodiments, the configuration or indication may be carried via RRC, MAC CE or DCI. For example, the configuration or indication may be carried via a MCS field in DCI. In this way, the compression method may be implicitly configured or indicated to the terminal device 110. In some alternative embodiments, the network device 120 may transmit the indication directly via RRC, MAC CE or DCI. In this way, the compression method may be explicitly configured or indicated to the terminal device 110.

In these embodiments, the terminal device 110 may start 336 the compression of the CSI at a predetermined timing after the reception of the indication. In some alternative embodiments, the terminal device 110 may transmit 337 an acknowledgement (ACK) for the indication to the network device 120 and start 338 the compression of the CSI at a predetermined timing after the transmission of the ACK. In some embodiments, the predetermined timing may be Y time units, where Y≥0.

Continue to refer to FIG. 3, upon compression of the CSI, the terminal device 110 transmits 340 the compressed CSI and the channel quality information to the network device 120. Some example embodiments on the transmission of the compressed CSI and the channel quality information will be described below in connection with Embodiments 5 to 6.

### Embodiment 5

In this embodiment, the terminal device 110 transmits 341, to the network device 120, the compressed CSI together with the channel quality information.

For convenience, the following description will be given by taking a CR and quantization information as examples of the set of compression parameters and a CQI as an example of the channel quality information.

In some embodiments, the terminal device 110 may implicitly report CR and quantization information based on CQI reported. In some embodiments, Table 10 below may be used in combination with Tables 1 to 4 as described above. For example, a CR may be determined from any of Tables 1 to 4 based on CQI and then the number of compressed bits may be determined. As another example, quantization information may be determined from any of Tables 5 to 9 based on CQI and then the number of compressed bits may be determined. With Table 10, there is no additional report for CR and overhead may be reduced.

TABLE 10
Example of CSI fields in CSI Report

| CSI fields | bitwidth |
|---|---|
| Compressed CSI | Nbits |
| CQI | 4-bit |
| Other information | . . . |

Alternatively, Nbits in Table 10 may be the maximum number of bits for compressed CSI. For those compressed CSI with the number of bits smaller than Nbits, the terminal device 110 may pad 0 to the compressed bits so as to become Nbits.

For example, the number of bits for compressed CSI may be calculated based on at least one of the following parameters (if reported): CQI, PMI, layer indicator (LI), RI, CSI-RS resource indicator (CR1), CR, quantization information.

In some embodiments, the terminal device 110 may explicitly report CR and implicitly report quantization information based on CQI reported. In some embodiments, Table 11 below may be used.

TABLE 11
Example of CSI fields in CSI Report

| CSI fields | bitwidth |
|---|---|
| Compression ratio | k_CR |
| Compressed CSI | Nbits |
| CQI | 4-bit |
| Other information | . . . |

In Table 11, K_CR denotes the number of bits to indicate the applied compression ratio. K_CR may depend on the number of configured or supported CRs (denoted as N_CR), for example, K_CR=ceil (log 2 (N_CR)). It is to be understood that this equation is merely an example, any other suitable ways are also feasible. In this embodiment, quantization information may be determined implicitly by CR or CQI as described in Tables 5 to 9.

In some embodiments, the terminal device 110 may explicitly report quantization information and implicitly report CR based on CQI reported. In some embodiments, Table 12 below may be used.

TABLE 12
Example of CSI fields in CSI Report

| CSI fields | bitwidth |
|---|---|
| Quantization method | k_q |
| Compressed PMI | Nbits |
| CQI | 4-bit |
| Other information | . . . |

In Table 12, k_q denotes the number of bits to quantize one element of encoder output dimension. k_q may depend on the number of configured or supported quantization methods (denoted as N_q), for example, k_q=ceil (log 2 (N_q)). It is to be understood that this equation is merely an example, any other suitable ways are also feasible. In this embodiment, CR may be determined implicitly by quantization information or CQI as described in Tables 1 to 4.

In some embodiments, the terminal device 110 may explicitly report CR and quantization information. In some embodiments, Table 13 below may be used.

TABLE 13
Example of CSI fields in CSI Report

| CSI fields | bitwidth |
|---|---|
| Quantization method | k_q |
| Compression ratio | k_CR |
| Compressed PMI | Nbits |
| CQI | 4-bit |
| Other information | . . . |

In Tables 10 to 13, “Other information” may be other CSI including one or more of CR1, RI, LI, PMI, CQI, etc., Tables 10 to 13 only show one entry per each quantity, and the reporting content may be per codeword, per transport block (TB), per UE panel, per transmission and reception point (TRP), per rank and so on. The same one of different compression methods may be applied per codeword, per TB, per UE panel, per TRP, per rank and so on.

In some embodiments, a bitwidth for CQI may be ceil (log 2 (the number of CQI ranges defined in Table 1)) to indicate the applied range. In some embodiments, if multiple CQIs reported in one CSI report, the first/last CQI may be used as an indication of compression method applied to the compressed CSI. In some embodiments, if no compression is applied, a codebook based CSI feedback may be used instead. Alternatively, a special status all 0 or all 1 is reported as the compressed bits.

It is to be understood that Tables 10 to 13 are merely examples, and are not intended for limitation.

### Embodiment 6

In this embodiment, the terminal device 110 transmits, to the network device 120, the compressed CSI separately from the channel quality information. For example, the terminal device 110 may transmit the compressed CSI and the channel quality information in 2-part CSI report.

In some embodiments, the terminal device 110 may transmit 342 the channel quality information in a first part of a CSI report (i.e., part 1 CSI report), for example as shown in Table 14, and transmit 343 the compressed CSI in a second part of the CSI report (i.e., part 2 CSI report), for example as shown in Table 15. In some embodiments, the CSI in the first part may be used to indicate compression information of the compressed CSI in the second part.

TABLE 14
Example of CSI fields in Part 1 CSI Report

| CSI fields | bitwidth |
|---|---|
| CQI | 4-bit |
| Other information in part 1 CSI report | . . . |

TABLE 15
Example of CSI fields in Part 2 CSI Report

| CSI fields | bitwidth |
|---|---|
| Compressed PMI | Nbits |
| Other information in part 2 CSI report | . . . |

As shown in Table 14, part 1 CSI report may comprise a CQI field. In some embodiments, the CQI field may be used to indicate the Nbits needed for the compressed CSI in part 2 CSI report as shown in Table 15.

In some embodiments, based on the channel quality information, the terminal device 110 may apply the relationship between the channel quality information and the set of compression parameters (for example, as shown in Tables 1 to 4) to determine the compressed method. Then the terminal device 110 may calculate the Nbits. Assuming that the set of compression parameters comprise a CR and quantization bits. For example, Nbits=applied CR*input dimension of the encoder. As another example, Nbits=applied CR*input dimension of the encoder*quantization bits. Of course, any other suitable ways are also feasible. In this way, the bitwidth of the compressed CSI field may be determined indirectly.

In some alternative embodiments, a relationship between the channel quality information and the bitwidth of the compressed CSI field may be directly built. In some embodiments, the relationship may be predefined. In some embodiments, the relationship may be signaled by the network device 120. In some embodiments, the relationship may be reported by the terminal device 110. For example, Tables 16 to 17 may be used.

TABLE 16
Example of a mapping between CQI Index
and Number of Compressed Bits

| CQI index | Nbits for Compressed PMI |
|---|---|
| CQI < CQI_1 | Nbits_1, or no compression |
| CQI_1 ≤ CQI < CQI_2 | Nbits_2 |
| CQI_2 ≤ CQI < CQI_3 | Nbits_3 |
| . . . | . . . |
| CQI_(k − 1) ≤ CQI | Nbits_k |

TABLE 17
Example of a mapping between CQI Index
and Number of Compressed Bits

| CQI index | Nbits for Compressed PMI |
|---|---|
| CQI < CQI_1 | (Nbits_1_1 or no compression, |
| | Nbits_1_2 or no compression) |
| CQI_1 ≤ CQI < CQI_2 | (Nbits_2_1, Nbits_2_2) |
| CQI_2 ≤ CQI < CQI_3 | (Nbits_3_1, Nbits_3_2) |
| . . . | . . . |
| CQI_(k − 1) ≤ CQI | (Nbits_3_1, Nbits_3_2) |

In Table 17, multiple compression bit numbers are defined for the same threshold or range. It is to be understood that Tables 16 to 17 are merely examples, and are not intended for limitation.

In some embodiments, the terminal device 110 may transmit, in the first part of the CSI report, at least one compression parameter in a set of compression parameters, the set of compression parameters being associated with the compression method. For example, part 1 CSI report may comprise one or more CSI fields for CR, quantization information or size of the compressed CSI to directly or indirectly indicate Nbits needed for the compressed CSI in part 2 CSI report. Tables 18 to 20 show some examples of part 1 CSI report in this case.

TABLE 18
Example of CSI fields in Part 1 CSI Report

| CSI fields | bitwidth |
|---|---|
| Compression ratio | k_CR |
| Other information in part 1 CSI report | . . . |

TABLE 19
Example of CSI fields in Part 1 CSI Report

| CSI fields | bitwidth |
|---|---|
| Compression ratio | k_CR |
| Quantization | k_q |
| Other information in part 1 CSI report | . . . |

TABLE 20
Example of CSI fields in Part 1 CSI Report

| CSI fields | bitwidth |
|---|---|
| Size of Compressed PMI | k_s |
| Other information in part 1 CSI report | . . . |

In Table 20, k_s denotes the number of bits to indicate the choice of Nbits. k_s may depend on the number of configured or supported compression bits (denoted as N_s), for example, k_s=ceil (log 2 (N_s)). For example, if the terminal device 110 supports 100-bit, 200-bit, 300-bit, and 400-bit compression, k_s=2. It is to be understood that this equation is merely an example, and any other suitable ways are also feasible. Further, it is to be understood that Tables 14 to 20 are merely examples, and are not intended for limitation.

Continue to refer to FIG. 3, upon reception of the CSI report comprising the compressed CSI and the channel quality information, the network device 120 determines 350 the compression method applied to the compress CSI based on the channel quality information. The determination of the compression method at the network device 120 is similar with the determination 320 of the compression method at the terminal device 110 as described above, and thus is not repeated here for concise.

Upon determination of the compression method, the network device 120 recoveries 360 CSI based on the compression method and the compressed CSI. In some embodiments, the recovery may comprise a decoding part of an autoencoder. In some embodiments, the recovery may comprise a decoding part of a transformer.

In some embodiments where 2-part CSI report is received, the network device 120 may receive part 1 CSI report first. The part 1 CSI report comprises the channel quality information. Based on the channel quality information, the network device 120 may determine compression information of the compressed CSI in part 2 CSI report. Then the network device 120 may receive the compressed CSI in the part 2 CSI report based on the compression information. In other words, as the network device 120 receives part 1 CSI report first, the network device 120 can decode the bitwidth (Nbits) of the compressed CSI field comprised in part 2 CSI report.

In some embodiments, based on the channel quality information received in part 1 CSI report, the network device 120 may apply the relationship between the channel quality information and the set of compression parameters (for example, as shown in Tables 1 to 4) to determine the compressed method. Then the network device 120 may calculate the Nbits. Assuming that the set of compression parameters comprise a CR and quantization bits. For example, Nbits=applied CR*input dimension of the encoder. As another example, Nbits=applied CR*input dimension of the encoder*quantization bits. Of course, any other suitable ways are also feasible. In this way, the bitwidth of the compressed CSI field may be determined indirectly.

In some alternative embodiments, a relationship between the channel quality information and the bitwidth of the compressed CSI field may be directly built. In some embodiments, the relationship may be predefined. In some embodiments, the relationship may be signaled by the network device 120. In some embodiments, the relationship may be reported by the terminal device 110. For example, Tables 16 to 17 may be used.

In this way, the bitwidth of the compressed CSI field in the part 2 CSI report may be directly determined. Further, CSI feedback overhead may be balanced and multiple compression bit numbers may be supported.

So far, an AI or ML based CSI feedback according to the present disclosure is described. In this way, a relationship between a compression method and channel quality is defined, and the applied compression method is reported implicitly via channel quality report. Accordingly, information required to align parameters of encoder and decoder is exchanged. An adaptive compression method is supported. UCI format for compressed CSI feedback is designed.

### Example Implementation of Methods

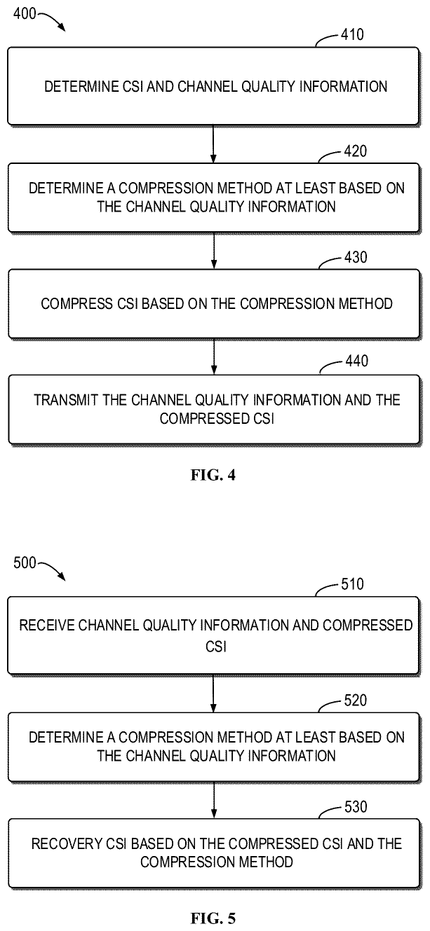

Corresponding to the above process, embodiments of the present disclosure provide methods of communication implemented at a terminal device and a network device. These methods will be described below with reference to FIGS. 4 and 5.

FIG. 4 illustrates an example method 400 of communication implemented at a terminal device in accordance with some embodiments of the present disclosure. For example, the method 400 may be performed at the terminal device 110 as shown in FIG. 1. For the purpose of discussion, in the following, the method 400 will be described with reference to FIG. 1. It is to be understood that the method 400 may include additional blocks not shown and/or may omit some blocks as shown, and the scope of the present disclosure is not limited in this regard.

At block 410, the terminal device 110 determines CSI and channel quality information based on a measurement on a set of RSs from the network device 120. In some embodiments, the CSI may comprise at least information of a precoding matrix.

At block 420, the terminal device 110 determines a compression method at least based on the channel quality information. In some embodiments, the compression method may be an AI or ML based compression comprising at least an encoding part of an autoencoder or a transformer.

In some embodiments, the terminal device 110 may determine a set of compression parameter values based on at least one of the following: a mapping between the channel quality information and at least one compression parameter value in the set of compression parameter values, or a mapping among at least two compression parameter values in the set of compression parameter values.

In some embodiments, the set of compression parameter values may comprise at least one of the following: a compression ratio, the number of quantization bits, or the number of compressed bits.

In some embodiments, if channel quality indicated by the channel quality information is below first threshold quality, the terminal device 110 may determine a first predetermined compression method as the compression method.

In some embodiments, if channel quality indicated by the channel quality information is below second threshold quality, the terminal device 110 may determine that no compression is applied.

In some embodiments, if channel quality indicated by the channel quality information is above third threshold quality, the terminal device 110 may determine a second predetermined compression method as the compression method.

At block 430, the terminal device 110 compresses the CSI based on the compression method.

In some embodiments, the terminal device 110 may transmit, to the network device 120, an indication of the compression method, and start the compressing of the channel state information at a predetermined timing after the transmission of the indication or a reception of a confirmation for the indication.

In some embodiments, the terminal device 110 may receive, from the network device 120, an indication of the compression method, and start the compressing of the channel state information at a predetermined timing after the reception of the indication or a transmission of an acknowledgement for the indication.

At block 440, the terminal device 110 transmits, to the network device 120, the channel quality information and the compressed CSI.

In some embodiments, the terminal device 110 may transmit, to the network device 120, at least one compression parameter in the set of compression parameters.

In some embodiments, the terminal device 110 may transmit, to the network device 120, an indication of the compression method, and receive, from the network device 120, a configuration updated based on the compression method. The configuration may comprises at least one of the following: a time-domain configuration, a frequency-domain configuration, an antenna-port-domain configuration, a beam-domain configuration, a resource for the transmission of the compressed CSI, or a format for the transmission of the compressed CSI.

In some embodiments, the terminal device 110 may transmit the channel quality information in a first part of a CSI report, and transmit the compressed CSI in a second part of the CSI report. The channel quality information in the first part may be used to indicate compression information of the compressed CSI in the second part.

In some embodiments, the terminal device 110 may further transmit, in the first part of the CSI report, at least one compression parameter in a set of compression parameters, the set of compression parameters being associated with the compression method.

With the method of FIG. 4, the applied compression method may be reported implicitly via channel quality report. CSI feedback overhead and compression performance may be balanced.

FIG. 5 illustrates an example method 500 of communication implemented at a network device in accordance with some embodiments of the present disclosure. For example, the method 500 may be performed at the network device 120 as shown in FIG. 1. For the purpose of discussion, in the following, the method 500 will be described with reference to FIG. 1. It is to be understood that the method 500 may include additional blocks not shown and/or may omit some blocks as shown, and the scope of the present disclosure is not limited in this regard.

At block 510, the network device 120 receives, from the terminal device 110, channel quality information and compressed CSI.

In some embodiments, the network device 120 may receive the channel quality information in a first part of a CSI report, and determine, based on the channel quality information, compression information of the compressed CSI in a second part of the CSI report. Then the network device 120 may receive, based on the compression information, the compressed CSI in the second part of the CSI report.

In some embodiments, the network device 120 may receive, in the first part of the CSI report, at least one compression parameter in a set of compression parameters, the set of compression parameters being associated with the compression method.

At block 520, the network device 120 determines a compression method applied for the compressed CSI based on the channel quality information. In some embodiments, the compression method may be an AI or ML based compression comprising at least an encoding part of an autoencoder or a transformer.

In some embodiments, the network device 120 may determine a set of compression parameter values based on at least one of the following: a mapping between the channel quality information and at least one compression parameter in the set of compression parameter values, or a mapping among at least two compression parameter values in the set of compression parameter values.

In some embodiments, the set of compression parameter values may comprise at least one of the following: a compression ratio, the number of quantization bits, or the number of compressed bits.

In some embodiments, the network device 120 may receive, from the terminal device 110, at least one compression parameter in the set of compression parameters.

In some embodiments, if channel quality indicated by the channel quality information is below first threshold quality, the network device 120 may determine a first predetermined compression method as the compression method.

In some embodiments, if channel quality indicated by the channel quality information is below second threshold quality, the network device 120 may determine that no compression is applied.

In some embodiments, if channel quality indicated by the channel quality information is above third threshold quality, the network device 120 may determine a second predetermined compression method as the compression method.

In some embodiments, the network device 120 may transmit, to the terminal device 110, an indication of the compression method.

At block 530, the network device 120 recoveries CSI based on the compressed CSI and the compression method. In some embodiments, the CSI may comprise at least information of a precoding matrix. In some embodiments, the recovering may comprise at least a decoding part of an autoencoder or a transformer.

In some embodiments, the network device 120 may receive, from the terminal device 110, an indication of the compression method, and update a configuration based on the compression method. The configuration may comprise at least one of the following: a time-domain configuration, a frequency-domain configuration, an antenna-port-domain configuration, a beam-domain configuration, a resource for transmission of the compressed CSI, or a format for transmission of the compressed CSI. Then the network device 120 may transmit the updated configuration to the terminal device 110.

With the method of FIG. 5, CSI may be recovered from compressed CSI based on compression method reported implicitly via channel quality report. CSI feedback overhead and compression performance may be balanced.

### Example Implementation of Device and Apparatus

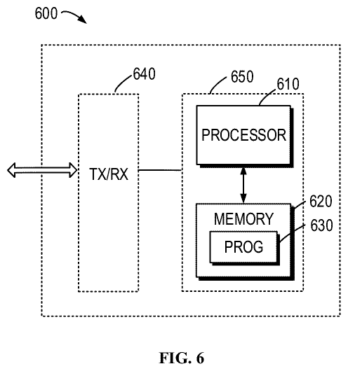

FIG. 6 is a simplified block diagram of a device 600 that is suitable for implementing embodiments of the present disclosure. The device 600 can be considered as a further example implementation of the terminal device 110 or the network device 120 as shown in FIG. 1. Accordingly, the device 600 can be implemented at or as at least a part of the terminal device 110 or the network device 120.

As shown, the device 600 includes a processor 610, a memory 620 coupled to the processor 610, a suitable transmitter (TX) and receiver (RX) 640 coupled to the processor 610, and a communication interface coupled to the TX/RX 640. The memory 610 stores at least a part of a program 630. The TX/RX 640 is for bidirectional communications. The TX/RX 640 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 630 is assumed to include program instructions that, when executed by the associated processor 610, enable the device 600 to operate in accordance with the embodiments of the present disclosure, as discussed herein with reference to FIGS. 1 to 5. The embodiments herein may be implemented by computer software executable by the processor 610 of the device 600, or by hardware, or by a combination of software and hardware. The processor 610 may be configured to implement various embodiments of the present disclosure. Furthermore, a combination of the processor 610 and memory 620 may form processing means 650 adapted to implement various embodiments of the present disclosure.

The memory 620 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 620 is shown in the device 600, there may be several physically distinct memory modules in the device 600.

The processor 610 may be of any type suitable to the local technical network, and may include one or more of general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

In some embodiments, a terminal device comprises a circuitry configured to: determine channel state information and channel quality information based on a measurement on a set of reference signals from a network device; determine a compression method at least based on the channel quality information; compress the channel state information based on the compression method; and transmit, to the network device, the channel quality information and the compressed channel state information.

In some embodiments, the channel state information comprises at least information of a precoding matrix.

In some embodiments, the compression method is an artificial intelligence or machine learning based compression comprising at least an encoding part of an autoencoder or a transformer.

In some embodiments, the circuitry may be configured to determine the compression method by: determining a set of compression parameter values based on at least one of the following: a mapping between the channel quality information and at least one compression parameter value in the set of compression parameter values, or a mapping among at least two compression parameter values in the set of compression parameter values.

In some embodiments, the set of compression parameter values comprises at least one of the following: a compression ratio, the number of quantization bits, or the number of compressed bits.

In some embodiments, the circuitry may be further configured to: transmit, to the network device, at least one compression parameter in the set of compression parameters.

In some embodiments, the circuitry may be configured to determine the compression method by: in accordance with a determination that channel quality indicated by the channel quality information is below first threshold quality, determining a first predetermined compression method as the compression method; in accordance with a determination that channel quality indicated by the channel quality information is below second threshold quality, determining that no compression is applied; or in accordance with a determination that channel quality indicated by the channel quality information is above third threshold quality, determining a second predetermined compression method as the compression method.

In some embodiments, the circuitry may be configured to compress the channel state information by: transmitting, to the network device, an indication of the compression method; and starting the compressing of the channel state information at a predetermined timing after the transmission of the indication or a reception of a confirmation for the indication.

In some embodiments, the circuitry may be configured to compress the channel state information by: receiving, from the network device, an indication of the compression method; and starting the compressing of the channel state information at a predetermined timing after the reception of the indication or a transmission of an acknowledgement for the indication.

In some embodiments, the circuitry may be further configured to: transmit, to the network device, an indication of the compression method; and receive, from the network device, a configuration updated based on the compression method, the configuration comprising at least one of the following: a time-domain configuration, a frequency-domain configuration, an antenna-port-domain configuration, a beam-domain configuration, a resource for the transmission of the compressed channel state information, or a format for the transmission of the compressed channel state information.

In some embodiments, the circuitry may be configured to transmit the channel quality information and the compressed channel state information by: transmitting the channel quality information in a first part of a channel state information report; and transmitting the compressed channel state information in a second part of the channel state information report, the channel quality information in the first part being used to indicate compression information of the compressed channel state information in the second part.

In some embodiments, the circuitry may be further configured to: transmit, in the first part of the channel state information report, at least one compression parameter in a set of compression parameters, the set of compression parameters being associated with the compression method.

In some embodiments, a network device comprises a circuitry configured to: receive, from a terminal device, channel quality information and compressed channel state information; determine a compression method applied for the compressed channel state information based on the channel quality information; and recovery channel state information based on the compressed channel state information and the compression method.

In some embodiments, the channel state information comprises at least information of a precoding matrix.

In some embodiments, the compression method is an artificial intelligence or machine learning based compression comprising at least an encoding part of an autoencoder or a transformer, and the recovering comprises at least a decoding part of an autoencoder or a transformer.

In some embodiments, the circuitry may be configured to determine the compression method by: determining a set of compression parameter values based on at least one of the following: a mapping between the channel quality information and at least one compression parameter in the set of compression parameter values, or a mapping among at least two compression parameter values in the set of compression parameter values.

In some embodiments, the set of compression parameter values comprises at least one of the following: a compression ratio, the number of quantization bits, or the number of compressed bits.

In some embodiments, the circuitry may be further configured to: receive, from the terminal device, at least one compression parameter in the set of compression parameters.

In some embodiments, the circuitry may be configured to determine the compression method by: in accordance with a determination that channel quality indicated by the channel quality information is below first threshold quality, determining a first predetermined compression method as the compression method; in accordance with a determination that channel quality indicated by the channel quality information is below second threshold quality, determining that no compression is applied; or in accordance with a determination that channel quality indicated by the channel quality information is above third threshold quality, determining a second predetermined compression method as the compression method.

In some embodiments, the circuitry may be further configured to: transmit, to the terminal device, an indication of the compression method.

In some embodiments, the circuitry may be further configured to: receive, from the terminal device, an indication of the compression method; update, based on the compression method, a configuration comprising at least one of the following: a time-domain configuration, a frequency-domain configuration, an antenna-port-domain configuration, a beam-domain configuration, a resource for transmission of the compressed channel state information, or a format for transmission of the compressed channel state information; and transmit the updated configuration to the terminal device.

In some embodiments, the circuitry may be configured to receive the channel quality information and the compressed channel state information by: receiving the channel quality information in a first part of a channel state information report; determining, based on the channel quality information, compression information of the compressed channel state information in a second part of the channel state information report; and receiving, based on the compression information, the compressed channel state information in the second part of the channel state information report.

In some embodiments, the circuitry may be further configured to: receive, in the first part of the channel state information report, at least one compression parameter in a set of compression parameters, the set of compression parameters being associated with the compression method.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory (ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1 to 5. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1. A method of communication, comprising:
determining, at a terminal device, channel state information and channel quality information based on a measurement on a set of reference signals from a network device;
determining a compression method at least based on the channel quality information;
compressing the channel state information based on the compression method; and
transmitting, to the network device, the channel quality information and the compressed channel state information.

2. The method of claim 1, wherein the channel state information comprises at least information of a precoding matrix.

3. The method of claim 1, wherein the compression method is an artificial intelligence or machine learning based compression comprising at least an encoding part of an autoencoder or a transformer.

4. The method of claim 1, wherein determining the compression method comprises:
determining a set of compression parameter values based on at least one of the following:
a mapping between the channel quality information and at least one compression parameter value in the set of compression parameter values, or
a mapping among at least two compression parameter values in the set of compression parameter values.

5. The method of claim 4, wherein the set of compression parameter values comprises at least one of the following:
a compression ratio,
the number of quantization bits, or
the number of compressed bits.

6. The method of claim 4, further comprising:
transmitting, to the network device, at least one compression parameter in the set of compression parameters.

7. The method of claim 1, wherein determining the compression method comprises:
in accordance with a determination that channel quality indicated by the channel quality information is below first threshold quality, determining a first predetermined compression method as the compression method;
in accordance with a determination that channel quality indicated by the channel quality information is below second threshold quality, determining that no compression is applied; or
in accordance with a determination that channel quality indicated by the channel quality information is above third threshold quality, determining a second predetermined compression method as the compression method.

8. The method of claim 1, wherein compressing the channel state information comprises:
transmitting, to the network device, an indication of the compression method; and
starting the compressing of the channel state information at a predetermined timing after the transmission of the indication or a reception of a confirmation for the indication.

9. The method of claim 1, wherein compressing the channel state information comprises:
receiving, from the network device, an indication of the compression method; and
starting the compressing of the channel state information at a predetermined timing after the reception of the indication or a transmission of an acknowledgement for the indication.

10. The method of claim 1, further comprising:
transmitting, to the network device, an indication of the compression method; and
receiving, from the network device, a configuration updated based on the compression method, the configuration comprising at least one of the following:
a time-domain configuration,
a frequency-domain configuration,
an antenna-port-domain configuration,
a beam-domain configuration,
a resource for the transmission of the compressed channel state information, or a format for the transmission of the compressed channel state information.

11. The method of claim 1, wherein transmitting the channel quality information and the compressed channel state information comprises:
transmitting the channel quality information in a first part of a channel state information report; and
transmitting the compressed channel state information in a second part of the channel state information report, the channel quality information in the first part being used to indicate compression information of the compressed channel state information in the second part.

12. The method of claim 11, further comprising:
transmitting, in the first part of the channel state information report, at least one compression parameter in a set of compression parameters, the set of compression parameters being associated with the compression method.

13. A communication method, comprising:
receiving, at a network device and from a terminal device, channel quality information and compressed channel state information;
determining a compression method applied for the compressed channel state information based on the channel quality information; and
recovering channel state information based on the compressed channel state information and the compression method.

14. The method of claim 13, wherein the channel state information comprises at least information of a precoding matrix.

15. The method of claim 13, wherein the compression method is an artificial intelligence or machine learning based compression comprising at least an encoding part of an autoencoder or a transformer, and
wherein the recovering comprises at least a decoding part of an autoencoder or a transformer.

16. The method of claim 13, wherein determining the compression method comprises:
determining a set of compression parameter values based on at least one of the following:
a mapping between the channel quality information and at least one compression parameter in the set of compression parameter values, or
a mapping among at least two compression parameter values in the set of compression parameter values.

17. (canceled)

18. The method of claim 13, further comprising:
receiving, from the terminal device, at least one compression parameter in the set of compression parameters.

19. The method of claim 13, wherein determining the compression method comprises:
in accordance with a determination that channel quality indicated by the channel quality information is below first threshold quality, determining a first predetermined compression method as the compression method;
in accordance with a determination that channel quality indicated by the channel quality information is below second threshold quality, determining that no compression is applied; or
in accordance with a determination that channel quality indicated by the channel quality information is above third threshold quality, determining a second predetermined compression method as the compression method.

20. The method of claim 13, further comprising:
transmitting, to the terminal device, an indication of the compression method.

21. (canceled)

22. (canceled)

23. (canceled)

24. A terminal device, comprising:
a processor configured to cause the terminal device to perform the method according to claim 1.

25. (canceled)
